(19) United States
(12) Patent Application Publication
(10) Pub. No.: US 2014/0306832 A1
(43) Pub. Date: Oct. 16, 2014

(54) Method And Apparatus For Remote Monitoring Of A Residence

(71) Applicant: Jonathan Goose, Boston, MA (US)

(72) Inventor: Jonathan Goose, Boston, MA (US)

(21) Appl. No.: 14/107,810

(22) Filed: Dec. 16, 2013

Related U.S. Application Data
(60) Provisional application No. 61/801,886, filed on Mar. 15, 2013.
(60) Provisional application No. 61/738,809, filed on Dec. 18, 2012.

(51) Int. Cl. G08C 17/02

(52) U.S. Cl. CPC G08C 17/02
USPC 340/870.09

(57) ABSTRACT

Embodiments disclosed herein relate to remote monitoring of at least one residence to determine whether or not the at least one residence has power. Embodiments disclosed herein enable a homeowner of the at least one residence or a third party to be notified of power loss of the at least one residence as well as restoration of the power. By providing residential power loss detection and enabling homeowners or third parties to be aware of the power loss detected, a homeowner or third party can react to the power loss in a timely manner, thereby preventing damage to the residence or to contents of thereof.

### RELATED APPLICATIONS

This application claims the benefit of U.S. Provisional Application No. 61/801,886, filed on Mar. 15, 2013, and U.S. Provisional Application No. 61/738,809, filed on Dec. 18, 2012. The entire teachings of the above applications are incorporated herein by reference.

### BACKGROUND OF THE INVENTION

A homeowner may have multiple residences. Some homeowner residences may be vacation homes or time shares that are only periodically frequented by the homeowner.

### SUMMARY OF THE INVENTION

A method, corresponding system, apparatus, and non-transitory computer-readable medium for remote monitoring of a residence and enabling a notification of power loss of the residence are disclosed herein.

According to one embodiment, a method for remotely monitoring a residence may comprise monitoring an operational state of at least one network device via a network. The at least one network device may be operatively coupled to a power source of the residence for power. The method may determine a status of the power source based on the operational state of the at least one network device. The method may generate a notification that provides an indication of the status of the power source of the residence.

The notification may include a “power lost” indication or a “power restored” indication, and the notification may be automatically generated responsive to detection of a change of the operational state of the at least one network device. A notification may be a visually displayed indicator, audible indicator, or an electronic indicator that carries the notification from an electronic device to another electronic device via a wired or wireless communications path.

Determining the operational state may include monitoring communications from the at least one network device. The communications monitored may be bi-directional or uni-directional communications. The bi-directional communications may include request messages being sent to the at least one network device and response messages being sent from the at least one network device in response to the request messages. The unidirectional communications may include status messages sent from the at least one network device. The notification generated may be a power loss notification based on a loss of one or more response messages or one or more status messages.

The method may include suppressing the notification generated based on a fault condition of the network or determining an alternative network via which to transmit the notification based on the fault condition of the network.

The method may include enabling a user to select a presentation type for the notification generated, and the presentation type may include a list of at least one of: text type notification, e-mail type notification, voicemail type notification, registered service type notification, or a third-party type notification.

The method may include employing an application, such as an App on a smartphone, on a user device operatively coupled to the at least one network device via the network. The application may be configured to perform the monitoring, determining, and generating. The application employed may enable a user to select the residence among a plurality of residences available to be remotely monitored. The method may include presenting notifications generated for multiple residences selected by the user, wherein the notifications for the multiple residences are selectively presented in a synchronous or asynchronous manner as defined by the user. The method may include storing the application on a server operatively coupled to the network and downloading the application from the server, wherein the application is configured to provide automatic configuration for each effectuating communications with the at least one network device based on the user device being operatively coupled to the network via a connection to a Wi-Fi or local wireless network of the residence. The automatic configuration may include an Internet Protocol (IP) network and use of a subnet mask. If the user device is connected to a network connection of the residence, the application may be further configured to detect a network configuration of the at least one network device and automatically configured to enable later communications between the at least one network device and the user device.

The monitoring for the at least one network device may be performed for each of multiple residences. The monitoring may include causing communications to occur with the at least one network device in every residence in a daisychained manner. Determining the operational state of the power sources of the residences may be based on receipt of a communication's indicating that each at least one network device in the daisychain participated in the communications.

Another embodiment of a method for remotely monitoring at least one residence may comprise enabling a user to associate contact information of a personal communications device with contact information of at least one network device of at least one residence. The at least one network device may be powered by a power source of the respective residence. The method may observe the at least one network device via a network in determining a status of the power source based on an operational status of the at least one network device. The method may notify the user via the user device of a status of the power source based on results of the observing.

The observing may include one or more ping requests, and the state of power may be determined to be a power loss based on a timeout of one or more responses to the at least one ping request.

The personal communications device may be a smart phone and may comprise transmitting an application to the smart phone via the network or providing information to the smart phone to enable a user to initiate downloading of the application.

The method may include enabling the user to associate a third party responsible for providing power to at least one residence and may further include notifying the third-party based on a change in the status of the power loss determined.

The at least one network device may be located at a location external from at least one of the plurality of residences.

The observing and notifying may be done on a subscription service basis, one-time basis, on-demand basis, or no fee on-going basis.

According to another embodiment, an apparatus for remotely monitoring a residence may comprise a processor operatively coupled to a network interface and be powered by a power source of a residence. The apparatus may further comprise a non-transitory computer-readable medium coupled to the processor, the non-transitory computer-readable medium may have encoded thereon a sequence of instructions which, when loaded and executed by the processor, causes the processor to send messages to a power loss monitoring device via a network operatively coupled to the processor via the network interface.

Another example embodiment disclosed herein includes an apparatus corresponding to operations consistent with the method embodiments described herein.

Further, yet another example embodiment may include a non-transitory computer-readable medium having stored thereon a sequence of instructions which, when loaded and executed by a processor, causes the processor to complete methods consistent with the method embodiments described above.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram of an embodiment of a system for remote monitoring of a residence.

FIG. 1B is a flow diagram of an embodiment of a method for remote monitoring of a residence.

FIG. 1C is a block diagram of another embodiment of a system for remote monitoring of a residence.

FIG. 2A is a flow diagram of another embodiment of a method for remote monitoring of a residence.

FIG. 2B is a flow diagram of another embodiment of a method for remote monitoring of a residence.

FIG. 3 is a block diagram of an example embodiment of a client device.

FIG. 4A is a block diagram of the client device in communications with one or more remote devices (e.g., residential network devices) over the computer network.

FIG. 4B is a block diagram of another example embodiment for monitoring power of multiple residences.

FIG. 5 is an example timing diagram for an example embodiment for generating a power outage notification.

FIG. 6 is a block diagram of an example internal structure of a computer in which various embodiments of the present invention may be implemented.

### DETAILED DESCRIPTION OF THE INVENTION

A description of example embodiments of the invention follows.

Loss of electrical power in a residence may have damaging effects. For example, a power outage may result in frozen pipes in the residence, loss of food due to spoilage caused by lack of refrigeration, or water damage due to non-operational sump pumps. A homeowner may not be present at the residence for days, weeks, or even months at a time. For example, the residence may be the homeowner's secondary residence or time share. Embodiments disclosed herein detect power loss in the residence and enable the homeowner or a third party to be notified of the power loss. The homeowner may employ services of others to assist in mitigating damage resulting from the power loss (e.g., power outage). If a power outage occurs at the residence, notification of the power outage, optionally including a time and duration of the power outage, may be of benefit to the homeowner or a third party.

According to one embodiment, a user may have multiple residences and may have a need for monitoring power of each of the multiple residences. According to an example embodiment, the user may install an application (e.g., an “App”) on a user device, such as a smart phone, cell phone, tablet, computer desktop, laptop, or any other suitable electronic device, and proceed to bring the user device to each of the multiple residences for automatic configuration. At each residence the App may detect one or more active networks enabling the App to be automatically configured such that at least one network device of the residence may be monitored for operational state by the user device via the active network. As the user leaves the residence with the user device, the App on the user device may monitor the operational state of the at least one network device. The at least one network device may use a power source of the residence for power. The App may notify the user or a third party of a power outage detected based on the monitoring of the operational state.

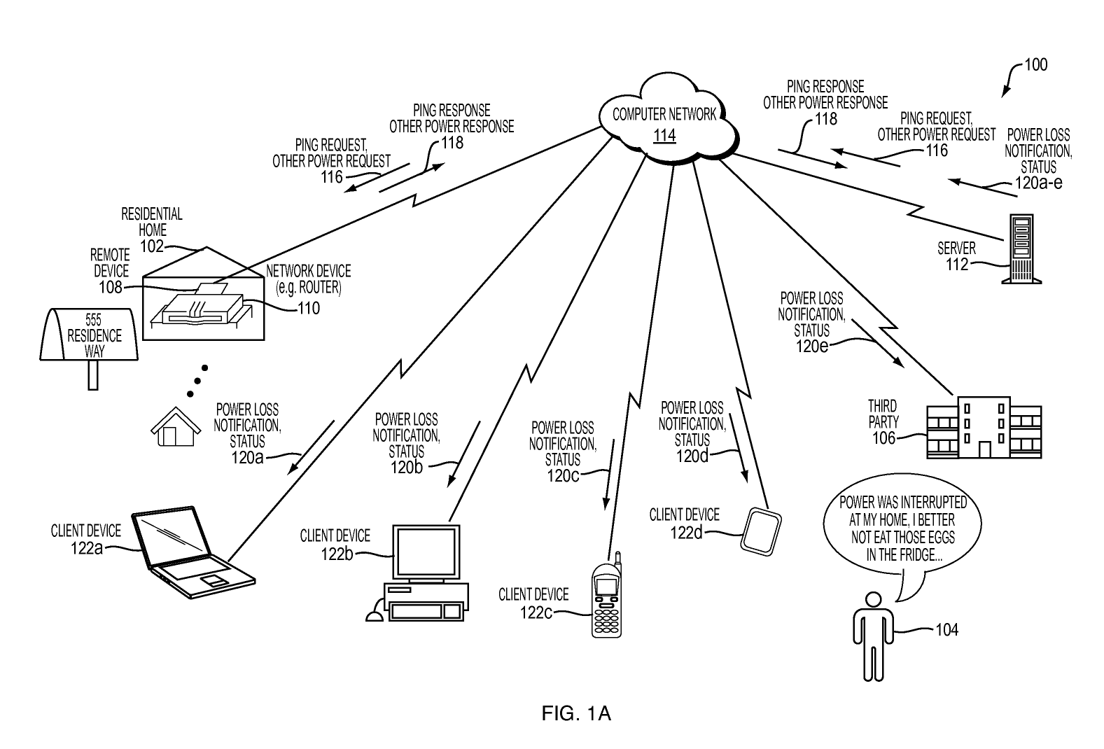

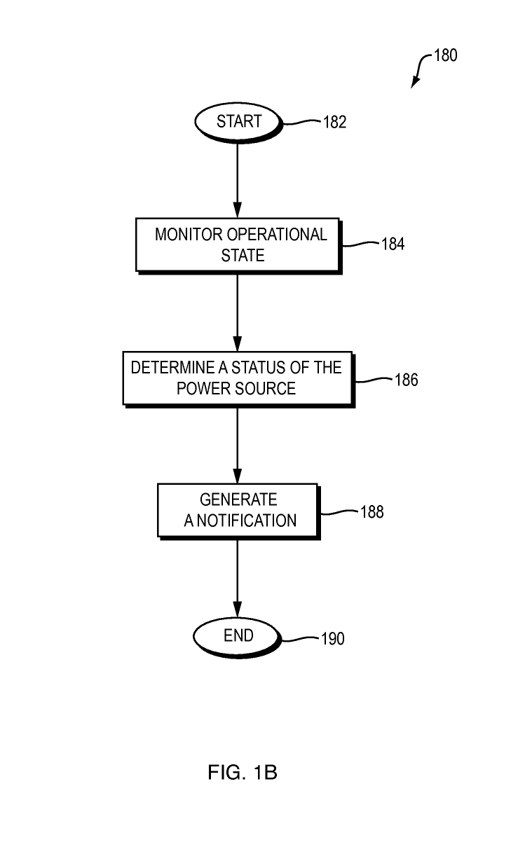

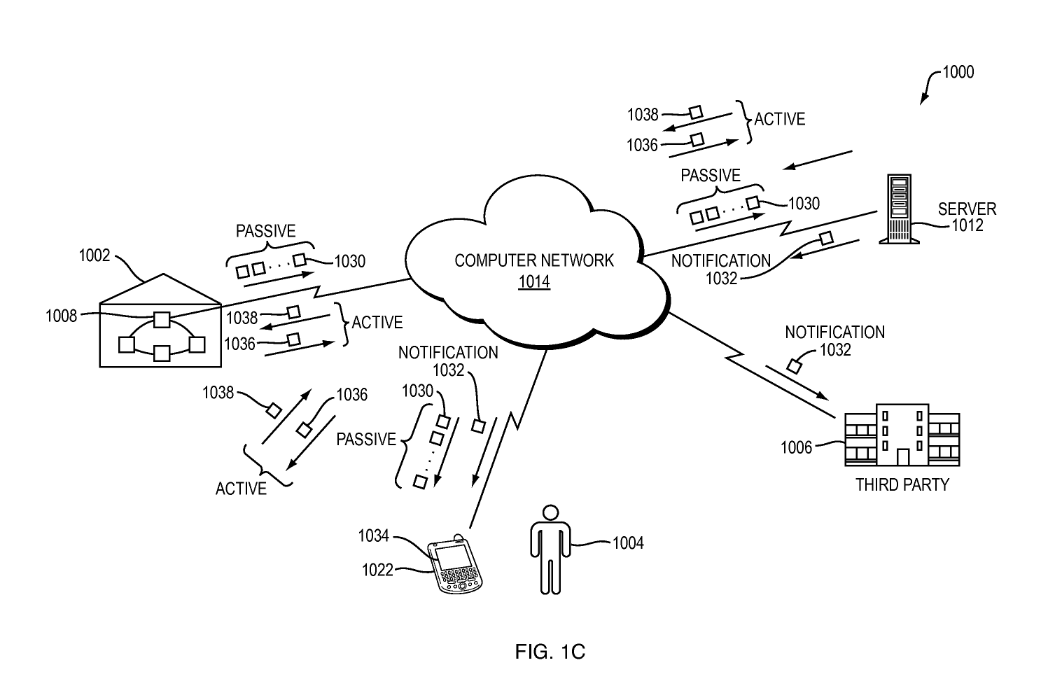

FIG. 1A is block diagram of an embodiment of a system 100 for remote monitoring of a residence 102. According to one embodiment, the system 100 may enable remote monitoring of power (not shown) in the residence 100 and may enable notification to the homeowner 104 or third party 106 if electrical power in the homeowner's residence 102 is interrupted or terminated. The homeowner 104 may be an owner, renter, leaser, etc. of the residence 102. The system 100 may include a remote device 108 communicatively coupled to a router 110 or other suitable electronic device located within the residence 102 of the homeowner 104. According to one embodiment, the remote device 108 may be inserted into a connector of the router 110, or other suitable electronic device, such as a network-enabled television (not shown), radio (not shown), or kitchen appliance (not shown). According to another embodiment, the remote device 108 may be in the form of a dongle. The remote device 108 may be powered by the router 110 or other suitable electronic device, and the router 110 or other suitable electronic device may be in communications with a server 112 via a computer network 114. The computer network 114 may be a wide-area network (WAN), such as the Internet, a wireless network, local-area network (LAN), cellular network, or another suitable type of network.

According to one embodiment, detecting power loss may include utilizing network message requests 116 and responses 118 over the computer network 114 to determine whether or not the residence 102 is experiencing power loss. Network messages, such as ping messages (e.g., “pings”), or any other suitable network messages may be used. For example, the server 112 may monitor whether or not the remote device 108 responds to a network message request 112, such as a ping, in order to determine whether or not the remote device is experiencing a power loss. According to the example embodiment, the server may send a ping, such as an Internet Control Message Protocol (ICMP) echo request packet, over the computer network 114 to the remote device 108 located in the residence 102 of the homeowner 104. The server 112 may be configured to wait for network message responses 118, such as ICMP responses from the remote device 108 to determine power loss. For example, if a network message response 118 is not received before a predetermined time-out has expired, the server 112 may determine that the residence 102 is experiencing a power loss (e.g., power outage). According to another embodiment, power loss in the residence 102 may be determined based on a predetermined number of consecutive pings failing. The server 112 may be configured to ping the remote device 108 at a predetermined interval, such as every fifteen or twenty minutes. In addition, the server 112 may be configured to qualify the power loss determined based on qualification with additional back-up methods.

The server 112 may be located at a location determined by a service provider (not shown) of the homeowner 104. The server 112 may be configured to send a ping request 116 to the remote device 108 at predetermined intervals of time and detect a ping response 118 from the remote device 108 to the ping request 116. If power is terminated in the residence 102, the router 110 experiences power loss resulting in loss of power to the operatively coupled remote device 108. Thus, as a result of power loss in the residence 102, the remote device 108 may be unable to respond to the ping requests 116 sent by the server 112. The server 112 may detect a lack of response from the remote device 108 to the one or more ping requests 116, triggering power loss notification services (not shown) and back-up confirmation protocols (not shown) to be enabled by the server 112. A client, such as the residential homeowner 104, may receive a power loss notification 120a-d from the server 112 via a phone call, text message, email, or other suitable notification message automatically generated by the server 112 based on the lack of response detected. The client may receive the power loss notification 120a-d sent via the computer network 114 to the client device such as a smart phone (not shown), cell phone 122c, tablet 122d, computer desktop 122b, laptop 122a, or any other suitable electronic device. It should be understood that the terms user and client may be used interchangeable herein.

A back-up confirmation protocol may be enacted by the server 112 to determine if the lack of response from the remote device 108 to the one or more ping requests 116 is due to a failure of the router 110 (or other device) itself or loss of power in the residence 102. Depending upon services available to the residence 102, the back-up confirmation protocol may include pinging a cable box (not shown) located in the residence 102 through a cable service provider (not shown) of the homeowner 104. The back-up confirmation protocol may include pinging the residence 102 via Smart-Grid technologies (not shown).

According to yet another embodiment, the homeowner may have an analog or digital answering machine (not shown) or FAX device (not shown) located within the residence 102. Determining whether or not power is interrupted or terminated in the residence 102 may include placing a call to the number answered by the answering machine or FAX device. Power loss in the residence 102 may be determined based on whether or not the call is answered. For example, if the call is not answered by either a human or the machine device, a determination of power loss in the residence may be determined.

The server 112 may notify the client, such as the homeowner 104, at predetermined intervals, of the status (e.g., loss or no loss) of electrical power in the homeowner's residence 102 based on communications with the remote device 108 within the homeowner's residence and utilization of embodiments of back-up methods.

Upon restoration of power in the residence 102, the server 112 may provide a restoration notification (not shown) to the homeowner. According to one embodiment, a website (not shown) may enable the homeowner to log in and check status of power in the residence 102 in real time. A report (not shown) may be provided that details a duration of electrical power interruption in the residence 102. A time of electrical power loss in the residence 102 may be useful to the homeowner 104, even if the electrical power in the residence 102 was restored within a reasonably short period of time. For example, providing the homeowner with a time and duration of power loss in the residence 102 may enable the homeowner 104 to make a determination as to whether or not refrigerated goods are still edible.

In addition, the server 112 may be configured to notify the third party 106 of power loss in the homeowner's residence 102. For example, since batteries on an alarm system (not shown) may generally only last for seventy-two hours, after which time an alarm system may be powered off, the homeowner 104 may specify a security contact at a security company to receive the power loss notification 120e. Providing a power loss notification 120e to the third party may be advantageous due to security or health concerns of the homeowner 104. For example, the third-party notification 120e may be advantageous if the homeowner 104 is elderly, infirmed, or otherwise unable to communicate an electrical power outage in the residence 102. Further, even though a homeowner 104 may be present at the residence at the time of the power loss, the homeowner 104 may be unable to communicate the power loss to the electrical company. By detecting the power loss in the residence 102 and automatically generating and communicating the power loss notification to the third party 106, such as the electrical company, the homeowner's power may be restored earlier than if the homeowner had to communicate personally with the electrical company. The power loss notification 120a-e may include the geographical address of the residence experiencing the power loss. The third-party 106 may include one or more of a security company, power company, insurance company, property caretaker, condominium association, or child of elderly or infirmed parents. For example, the third party 106 may be an individual or party with an interest in being notified of power loss in the residence 102.

According to another embodiment the remote device 108 may be external to the residence 102.

According to another embodiment a method may monitor bi-directional communications signals between the residence and an external party. The method may identify a set of baseline communications signals or messages being sent from one or more remote network devices within the residence during periods of time when there is power in the residence. The method may further detect power loss within the residence based on a lack of communications of the set of baseline communications signals or messages being sent by the at least one network device over a given period of time. The method may still further generate a power loss notification message automatically and communicate the power loss notification message generated.

According to another embodiment, a service may be provided enabling communication of power loss notification and status of power in a residential home. A user, such as the residential homeowner 104, may register with the service and create an account. The user may be required to pay for remote monitoring services provided and accessed via the account. The service may enable a user to create a user login identification and password for the user's account. The service may enable a user to configure the account to specify geographical address information of the residential address to be monitored remotely by the service. The service may enable the user to specify an Internet Protocol address for use in monitoring the residence. The service may enable the user to specify an email address, phone number, third party, etc., to which power outage notifications may be sent. The account may present a display of power status in the residence to the user in real time. The account may be configured to generate one or more reports providing details regarding duration of electrical power interruption in the residence.

FIG. 1B is flow diagram (180) of an embodiment of a method for remote monitoring of a residence. The method may monitor an operational state of at least one network device via a network, the at least one network device operatively coupled to a power source of the residence for power (184). The method may determine a status of the power source based on the operational state of the network device (186). The method may generate a notification that provides an indication of the status of the power source of the residence (188). The method thereafter ends (190) in the example embodiment.

FIG. 1C is a block diagram 1000 of another embodiment of a system for remote monitoring of a residence. According to one embodiment, the system 1000 may enable remote monitoring of power (not shown) in the residence 1002 and may enable notification to a homeowner 1004 or third party 1006 if power in the homeowner's residence 1002 is interrupted or terminated. The system 1000 may include at least one network device 1008 operatively coupled to a power source (not shown) of the residence 1002 for power. Operatively coupling the at least one network device 1008 to the power source may be indirect (e.g., via a computer port or cable box) or direct (e.g., to a wall socket). The at least one network device 1008 may be a network-enabled television (not shown), radio (not shown), kitchen appliance (not shown), or any other suitable electronic network device. The computer network 1014 may be a wide-area network (WAN), such as the Internet, a wireless network, local-area network (LAN), cellular network, or another suitable type of network.

According to one embodiment, the server 1012 may be configured to monitor an operational state of the at least one network device 1008 via the computer network 1014. The monitoring may be passive monitoring. For example, the server 1012 may be configured to monitor passive messages 1030 transmitted by the at least one network device 1008, such as a periodic heartbeat message, or other suitable message. The server 1012 may be configured to detect that one of more of the passive messages 1030 are not received and may determine that the operational state of the at least one network device 1008 is down, thus determining that a status of the power source is non-operational, or down.

The server 1012 may generate a notification 1032 that provides an indication of the power source of the residence 1002. A third party 1006 may receive the notification 1032 and contact the homeowner 1004, caregiver (not shown) or take suitable action based on the received notification 1032. Alternatively, or in addition to the third party 1006, a client device 1022 may receive the notification 1032 and display a text message, sound an audible alarm, provide an indication of an email received, or take another suitable action to enable the user 1004 to be made aware that the power source of the residence 1002 is non-functional. Similarly, if the power source becomes operational and the at least one network device 1008 resumes transmission of the passive messages 1030, the server 1012 may determine that the status of the power source is up and the notification 1032 may provide an indication that the operational status of the power source of the residence is functional.

According to another embodiment, the client device 1022 may be configured to monitor the operational state of the at least one network device 1008 via the computer network 1014. For example, the client device 1022 may be configured to monitor the passive messages 1030 transmitted by the at least one network device 1008. For example, the client device 1022 may be configured to detect that one of more of the passive messages 1030 are not received and may determine that the operational state of the at least one network device 1008 is down, thus determining that the status of the power source is non-operational, or down. As such, the client device 1022 may generate a notification (not shown) that is displayed via a text message, sound an audible alarm, provide an indication of an email received, or take another suitable action via the client device or its associated display 1034 to enable the user 1004 to be made aware that the power source of the residence 1002 is non-functional. Similarly, if the power source becomes operational and the at least one network device 1008 resumes transmission of the passive messages 1030, the client device 1022 may determine that the status of the power source is up and the notification may provide an indication that the operational status of the power source of the residence is functional.

According to another scenario, the monitoring may be active monitoring. For example, the monitoring may include detecting whether or not a network response message 1036 is received from the at least one network device 1008 in response to a network request message 1038 sent to the at least one network device 1008. Network messages, such as ping messages (e.g., “pings”), or any other suitable network messages may be used.

According to one embodiment, the server 1012 may monitor whether or not the at least one network device 1108 responds to the network request message 1038 in order to determine the status of the power source based on the operational state of the at least one network device 1008. Similar to the passive monitoring scenario, the server 1012 may generate the notification 1032, which may provide the indication of the status of the power source of the residence. The notification 1032 may be sent to the third party 1006, client device 1022, or combination thereof, for the client device 1022 or the third party 1006 to determine further action for providing information for the homeowner 1004 of the received notification 1032. The information may indicate loss or restoration of the power source of the residence 1002.

According to another embodiment, the client device 1022 may monitor whether or not the at least one network device 1108 responds to the network request message 1038 in order to determine the status of the power source based on the operational state of the at least one network device 1008. Similar to the passive monitoring scenario, the client device 1022 may generate a notification to inform the homeowner 1004 of the received notification 1032, which may indicate loss or restoration of the power source of the residence 1002.

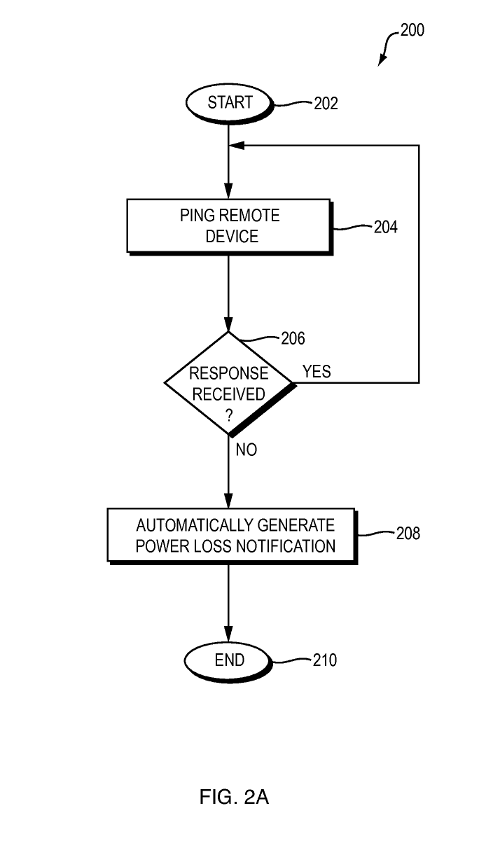

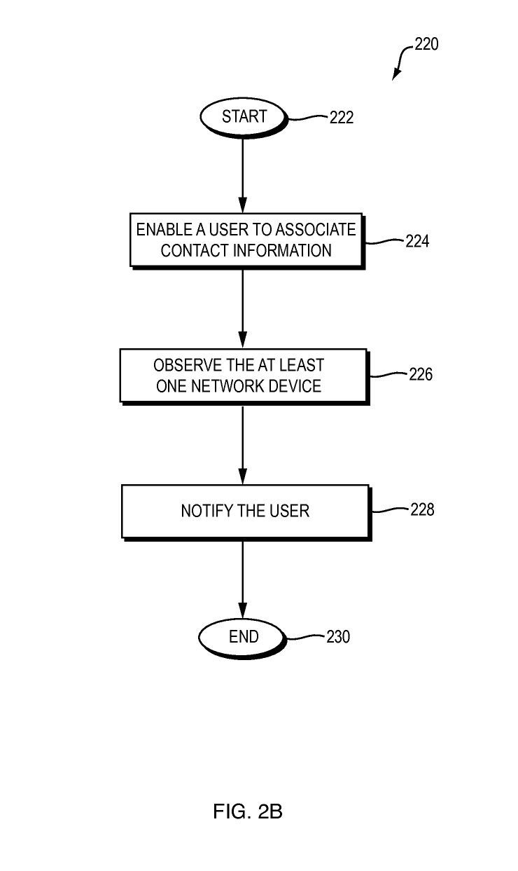

FIG. 2A is flow diagram (200) of another embodiment of a method for remote monitoring of a residence. The method may send ping request to a remote device (204) and check if a response to the ping request is received (206). If yes, the method may continue and sending ping requests to the remote device (204). If not, the method may generate a power loss notification (208) and the method thereafter ends (210) in the example embodiment.

FIG. 2B is flow diagram (220) of another embodiment of a method for remote monitoring of a residence. The method may enable a user to associate contact information of a personal communications device with contact information of at least one network device of at least one residence, the at least one network device being powered by a power source of the respective residence (224). The method may observe the at least one network device via a network in determining a status of the power source based on an operational status of the at least one network device (226). The method may notify the user via the user device of a status of the power source based on results of the observing (228). The method thereafter ends (230) in the example embodiment.

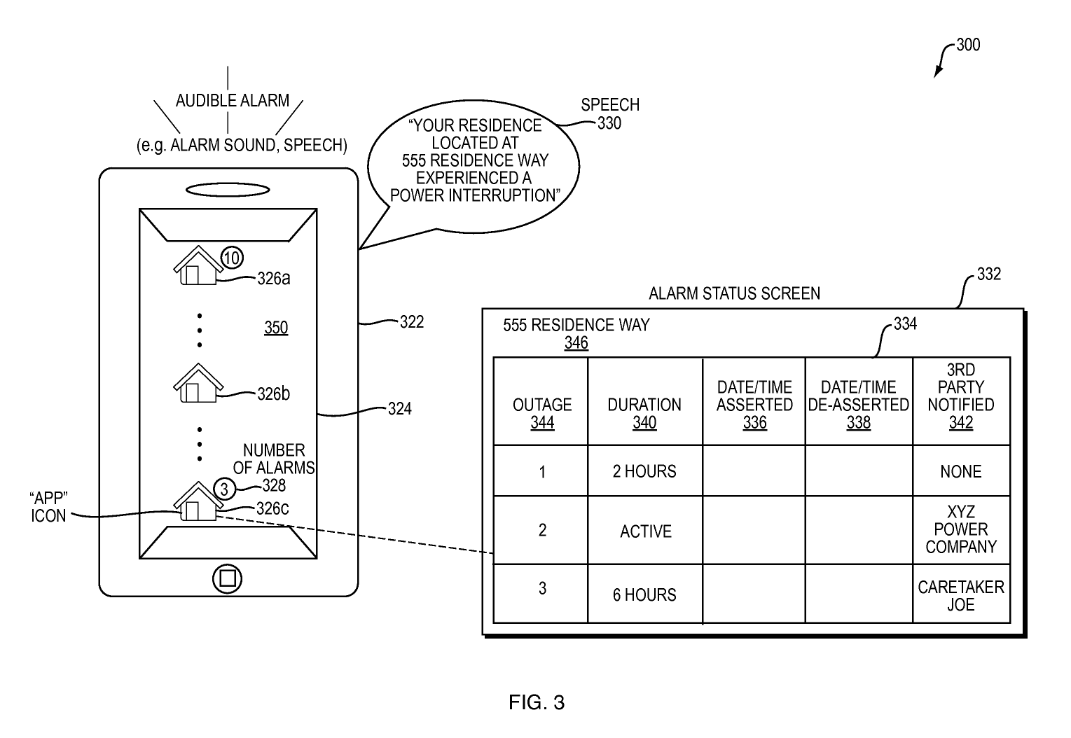

FIG. 3 is a block diagram 300 of an example embodiment of a client device 322. According to one embodiment, an application or “App” 350 on the client device 322 may communicate with a remote device (not shown) operatively coupled to the main power of a residence (not shown). The App 350 may be downloaded to the client's device, such as a client's smart phone (not shown), or other suitable client device that may communicate over a computer network (not shown).

The App 350 may be active or passive as described below. The App 350 may enable multiple residences (not shown) to be selected for monitoring and may show status for all residences being monitored by presenting the status for the multiple residences either simultaneously or independently. The status, such as a number of alarms 328 active or generated may be shown in any suitable manner, such as via the client device 322 display 324 that may represent each residence being monitored with an icon 326a-d.

Turning back to FIG. 1A, according to one embodiment, the App 350 may be downloaded from the server 112 communicatively coupled to the computer network 114. The App 350 may be configured to provide automatic configuration that may effectuate communications with the remote device 108 given that the App 350 is downloaded, installed, or otherwise utilized after installation with the client device 322 being in communications with the server 112 over the computer network 114 via the network connections provided by the residence 102, such as the residence 102.

Plug and play configuration may be enabled by the App 350 based on the download, installation, or otherwise utilization of the App 350 based on the client device 322 being in communications with the server 112 over the computer network 114 via the network connections provided by the residence 102. For example, the client device 322 may be located within a communication range of a wireless network (e.g., Wi-Fi) (not shown) of the residence 102 itself. Based on the App 350 being downloaded or installed with the client device 322 being located within a communication range of the residence network, the App 350 may be configured to detect, connect, and configure settings on the App 350 that are associated with the network of residence. For example, any routing or address information (e.g., Internet Protocol addresses, subnets, masks, etc.) may be automatically detected and configured on the client device 322 enabling later communications of the client device 322 located outside of the range of the residence network with the remote device 108 operatively coupled to the main power of the residence 102. For example, a subnet mask that may be used to determine what subnet an Internet Protocol address belongs to may be automatically detected and configured such that a user does not need to configure the setting manually.

Download and installation of the App 350 on the client device 322 with the client device 322 communicatively coupled with the network of the residence enables ease of use for the user 104 as configuration of the App 350 may be enabled to include automatic configuration of Internet Protocol (IP) network addresses, etc., that may be cumbersome for the user 104 to determine and may be automatically detected for the user based on the client device 322 being communicatively coupled to the network of the residence.

According to another embodiment, the user 104 may be prompted for settings associated with the residence itself to configure alarm notification options at the time of the App 350 download or installation. Since the client device 322 may be in communications with a network of the residence at the time of the App 350 download or installation, necessary configurations for power monitoring of the residence 102 may be automatically detected enabling a one time configuration for the user 104 to the proceed and use the App 322 for power monitoring of the residence 102. The user 104 may additionally be prompted to register with the power monitoring service at the time of the App 322 download or installation and provide any additional information, such as notification type (e.g., text, email, third party, etc), at the time of the registration.

According to another embodiment, a user may have multiple residences and may have a need for monitoring power of each of the multiple residences. According to the example embodiment, the user may install the App 350 on the client device 322 and proceed to bring the client device 322 to each residence. At each residence the App 350 may detect the one or more active networks in the residence and may prompt the user to select the one or more of the active networks that may be utilized by one more network devices communicatively coupled to the selected one or more networks. The App 350 may detect the at least one network device communicatively coupled to the selected one or more networks and may enable the user to select the at least one network device for designation as a remote device for enabling power monitoring of the residence.

The App 350 on the client device 322 may be automatically configured to enable communications via the computer network with the at least one network device designated. As the user leaves the residence with the client device 322, the App 350 on the client device 322 may communicate with the at least one network device designated (e.g., remote devices) in order to detect a power outage based on communications with the one or more remote devices over the computer network. The App 322 may notify the user or service registered of a power outage in the event a power outage is detected.

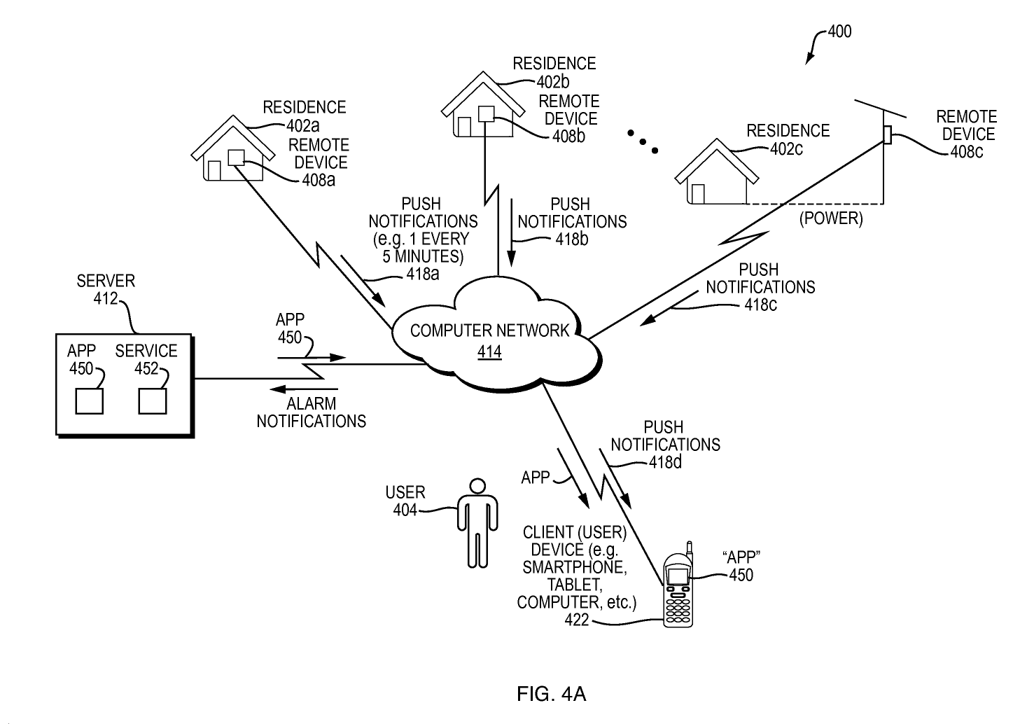

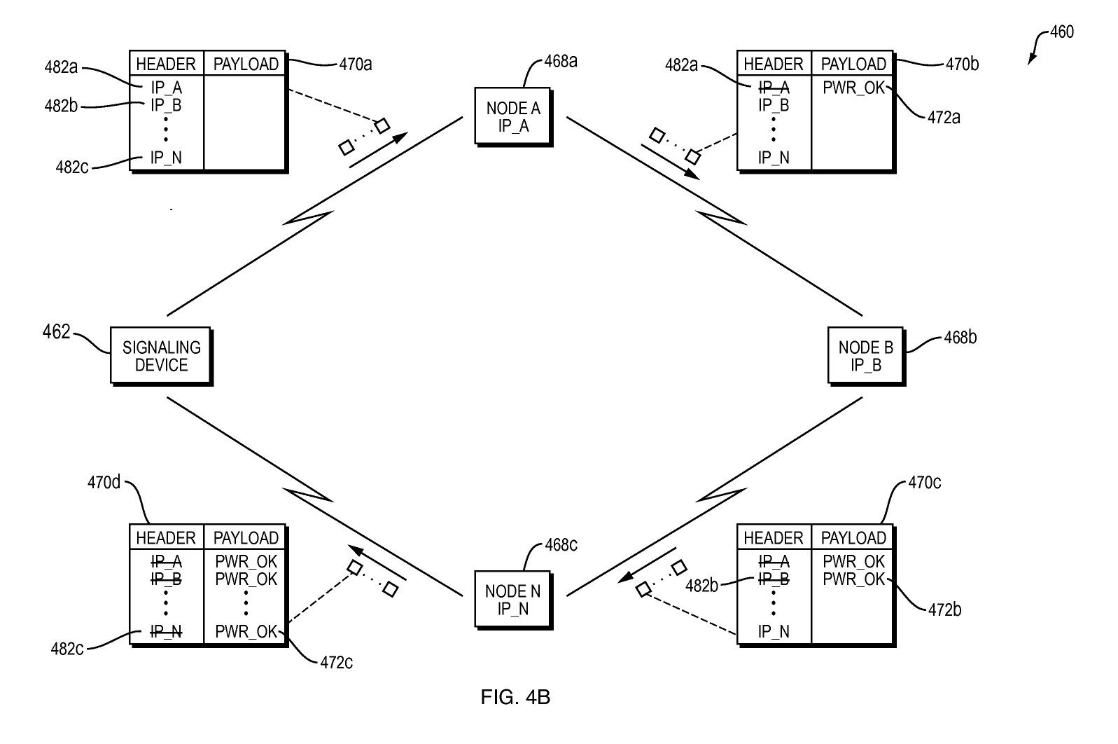

FIG. 4A is a block diagram 400 of a client device 422 in communications with one or more remote devices (e.g., residential network devices) 408a-d over a computer network 414. The one or more remote devices 408a-d may each be located in or outside of a residence and each may be coupled to the main power of the respective residence 402a-d and communicatively coupled to the computer network 414. The App 450 may be downloaded from a server 412 and may communicate with one or more remote devices 408a-d that are each coupled to the main power of at least one residence of the multiple residences 402a-d and the App 450 may determine whether or not to generate a power loss alarm for the at least one residence based on the communications with the one or more remote devices 408a-d. The communications may be uni-directional or bi-directional.

For example, the App 450 may determine whether or not to generate a power outage alarm by passively monitoring periodicity of messages sent at a given rate by one or more remote devices 408a-d over the computer network 414. The given rate may be every five minutes, or any other suitable default rate or rate configured by the user 404.

According to one embodiment, messages, such as push notifications 418a-d may be correlated by the App 450 such that the messages 418a-d are associated with the residence 402a-d including the remote devices 408a-d sending the messages. For example, the messages 418a-d may include content such as source IP address information, or other network information that may be correlated with the residences 402a-d based on an automatic detection of the source IP address or the other network information based on the source IP address or other network information having been detected or learned by the App 450 based on the App 450 being communicatively coupled to the network or network devices of the residences 402a-d.

The messages 418a-d sent by the remote devices 408a-d may be push notifications that are automatically generated by the remote devices 408a-d at a given rate. The App 450 may generate a power outage notification or alarm based on a loss of one or more push notifications during a given time period that is configurable by the user 404 via the App 450. A number of loss push notifications for a given time period may additionally be configured by the user 404 via the App 450.

According to one embodiment, the network devices of multiple residences, such as the multiple residences 402a-d of FIG. 4A may be configured to participate in daisychain communication. As such, monitoring of the network devices 408a-d may be distributed such that the client device 422 may receive consolidated power status information (not shown) for the multiple residences 402a-d instead of directly monitoring each residence's network devices. The monitoring may be performed for a network device for each of multiple residences, wherein the monitoring may include causing communications to occur across a network device in every residence in a daisy chain manner. As such, determination of the operational state of the power sources of the residences 402a-d may be based on receipt of a communication representing that every network device in the daisychain participated in the communications. According to another embodiment a service 452 may be provided by the server 412 enabling communication of power loss notification and status of power to be communicated to the App 450 installed on the client device 422.

FIG. 4B is a block diagram 460 of another example embodiment for monitoring power of multiple residences. Nodes (i.e., client devices) 468a-c of multiple residences may be configured to participate in daisychain communications, for example, via a computer network, in order to offload multiple communications that a client device would have to be involved in order to obtain a status of each residence. The computer network may be a wireless network or any other suitable network. A signaling device 462 and the nodes 468a-c may be operatively coupled over the computer network. The signaling device 462 may be another node (i.e. client device) or a server.

The signaling device 462 may send at least one power status query packet 470a over the computer network indicating a request for power status of the multiple nodes 468a-c. A first node 468a may receive the at least one power status query packet 470a that may include IP addresses of each of the multiple nodes 468a-c for which power status is being requested. The IP addresses may be included as part of the packet 470a's header, header extension, payload, or any other suitable portion of the packet 470a. The first node 468a may be configured to detect and remove its IP address from the power status query packet 470a and supplement a reserved portion of the power status query packet 470a with an indication of its power status 472a. The power status 472 may be a binary type of indication to indicate “ok” versus “not ok”, or, may be more a more complex indicator, for example, including power levels, or a history of power status. The power status 472 may be any suitable power status indication of either a present or past history of power status.

The reserved portion of the power status query packet 470a may be reserved for the power status of the first node 468a. The first node 468a may forward an updated power status query packet 470b to a next node 468b. The updated power status query packet 470b may be updated with respect to the power status query packet 470a in that it may include the power status 472a of the first node 468a and may exclude the first node's IP address 482a from the packet. The next node 468b may be configured to exclude its IP address 482b from the updated power status query packet 470b and may include its power status indication 472b in a reserved portion of a next updated power status query packet 470c that may be forwarded to another node 468c of the daisychain communications. Node 468c may be a last node of the daisychain communications. The last node 468c may be configured to exclude its IP address 482c from the next updated power status query packet 470b and may include its power status indication 472c in a reserved portion of the next updated power status query packet 470c and may forward the last updated power status query packet 470d to the signaling device 462 of the daisychain communications.

As such, the signaling device 462 may be configured to determine the power status of each of the multiple nodes 468a-c in the daisychain communications having its IP address removed from the power status query packet 470a and having a respective power status included in a reserved portion of the packet. The signaling device 462 may be configured to take action based on reception of the last updated power status query packet 470d. For example, the signaling device 462 may be configured to generate a notification (not shown) for at least one node of the multiple nodes 468a-c. For example, the signaling device 462 may be client device of a homeowner of multiple residences including the multiple nodes 468a-c. Generating the notification may include alerting the homeowner via a display on the signaling device 462 or sending a notification via email, text, to the homeowner. Alternatively, the signaling device 462 may be configured to send the cumulative or individual status to another device such as a server that may be configured to notify a homeowner or caregiver of power status of one or more residence associated with the multiple nodes 468a-c configured for daisychain communications.

According to an alternate embodiment the multiple nodes 468a-c may be in communications with a multicast server (not shown). Such an embodiment allows a client device, such as the signaling device 462 or the multiple nodes 468a-c, to send a single communication to a single server that may multicast the communication in a distributed manner to each residence. Optionally, the multicast message (not shown) may cause each residence to respond to the multicast server for aggregating a response to the client device, such as the signaling device 462, or the multicast message may cause each residence to respond directly to the client device, such as the signaling device 462.

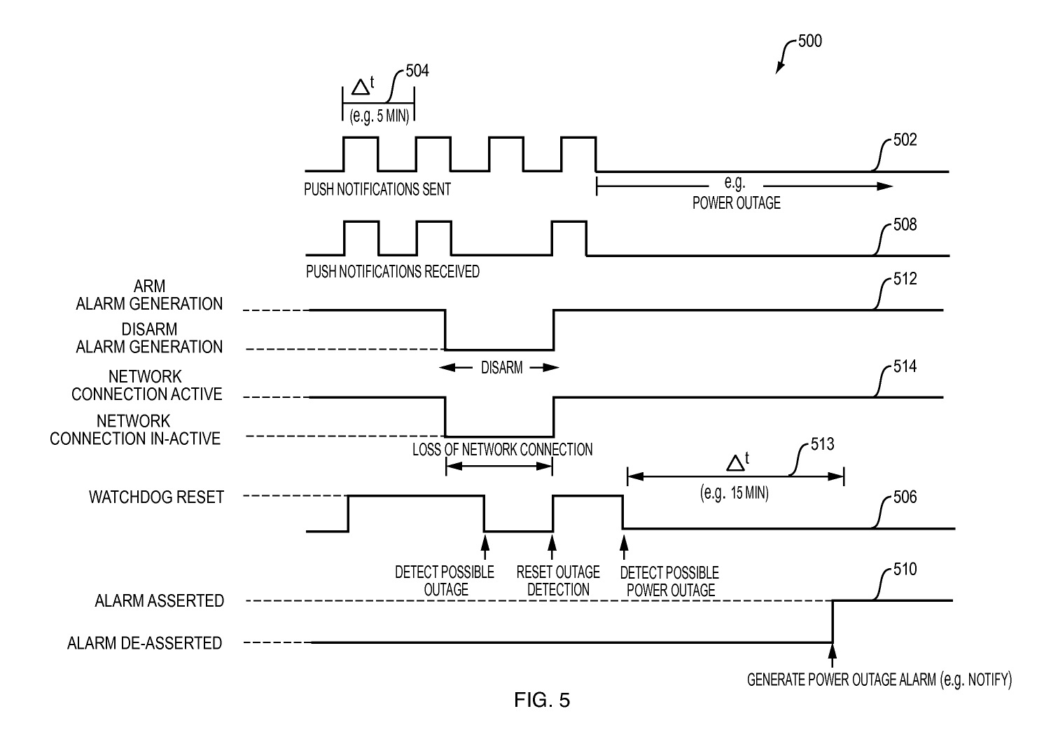

FIG. 5 is an example timing diagram 500 for an example embodiment for generating a power outage notification. In the example timing diagram 500, push notifications 502 from a remote device coupled to the main power of a residence is shown as being sent at a given rate, such as delta t 504. Delta t 504 may be 5 minutes or any other suitable time period. The App may be configured to determine whether or not to generate a power outage alarm or notification based on a configurable watchdog or other suitable setting such as a state of connection of the client device to the computer network. For example, the alarm generation may be disarmed, as shown by the arm alarm generation timing 512, if no network connection, such as a wireless connection, as shown by the network connection timing 514 is detected by the user device. The alarm generation may be disarmed for any other suitable reason for disarming.

As shown in FIG. 5, the watchdog timing 506 may be based on the push notification receive timing 508. For example, the watchdog timing 506 shows that the watchdog may be reset for each push notification received and asserted if consecutive push notifications are not received. Further, as shown in FIG. 5, the alarm generation timing 510 may be generated notifying a power outage event given that consecutive push notifications have not been received for a given time period wherein the alarm generation is armed, and the watchdog has not been reset, such as a 15 minute time period 513 illustrated in the timing diagram 500 of FIG. 5, or other suitable time period that may be configured by the user. Alternatively, the App on the client device may receive response notifications in response to actively sending a message, such as ping (not shown), to the one or more remote devices. As such, the App may be configured to generate power notifications for the at least one residence based on whether or not notifications, such as push notifications or response notifications to the messages sent, are received by the user device.

The remote device coupled to the main power of the residence may be a smart device, router, computer, or other suitable device that may be coupled to the main power (e.g., a power source that powers lights, appliances, etc. for the residence) of the residence. Alternatively, the remote device may have its own power source and may be communicatively coupled to a device that itself is coupled to the main power of the residence. The remote device may be coupled to a universal serial bus (USB) or other suitable port that provides power to the remote device wherein the USB or other suitable port that may be powered by a device coupled to the main power of the residence such as coupling to a power outlet in the residence. The remote device may receive power via a Category-5 (CAT5) cable coupled to a network or other device in the residence that this coupled to the main power of the residence. According to another embodiment, the remote device itself may be coupled to the main power source of the residence. For example, the remote device may be coupled to an outlet of the residence. The remote device may be an X10 based device coupled to the electrical wiring of the residence.

The alarm generated may be a visual alarm. For example an icon, such as the icon 326c shown in FIG. 3, may be presented by the App to the user on the user's smart phone display or other display of another suitable client (i.e., user) device. The icon or other suitable display indicator may change color, blink, or indicate an assertion of a power outage alarm for a residence in any other suitable manner. For example, the alarm may be displayed with an associated count 328 that indicates a number of alarms generated. A separate icon or other suitable display indicator may be presented to the user providing a power outage status for each residence being monitored for a power outage by the App.

A power outage alarm may be indicated via the generation of an audible alarm. Further, the App may enable a user to specify a sound for the audible alarm. Alternatively, the App may enable a user to specify that speech be used for communicating the audible alarm to the user. Speech 330 may include information regarding the alarm generated such as a number of alarms, times and dates for the alarms generated, residential addresses associated with the alarms generated, or other suitable information regarding the alarms generated. The user may receive more details via the App regarding the notification and actions taken based on the power outage alarm generated. For example, FIG. 3 shows an example embodiment of a display screen 332 that may present a user with information 334 related to the power outage alarm 344 associated with a residential address 346, such as information 334 regarding the date or time the alarm asserted 336 or de-asserted 338, duration of the alarm 340, a party such as a third party 342 that may have been notified of the power outage alarm, and other power outage information that may be useful to the user. For example, the alarm status screen may indicate an action taken by a third party based on the power outage alarm notification being communicated to the third party. For example, if a third party restored power to the residence by fixing an issue with a transformer in the area, or if a caretaker of the residence refueled a generator or other power source.

The App may present and enable the user to select from options associated with notifications of the alarms generated. The App may enable the user to select from options such as a visually displayed indication for alarm generated, an audible sound indication of the alarm generated, or a combination thereof. The App may additionally be configured to send a text, email or another notification to the user or a third party, or any combination thereof, based on App settings configured by the user, default settings thereof, or any combination of default or user settings configured on the App. Further, the App may enable the user to configure a delay for notifying the user of the power loss alarm generated. Further, the App may enable the user to enable and disable power monitoring of residences included in a residence list maintained by the App and the App may enable the user to configure a power monitoring schedule for at least one residence in the residence list maintained.

The user may be enabled to configure whether or not a generator or other back up system for power is configured in the home. Based on the type of power back up system configured, the user may be enabled to select whether or not a default for time based on the type of back up system should be used as a basis for power outage alarm generation or alternatively the user may enter the time. The App may enable the user to reconfigure the time, or the App may use a default time that is dynamically adjusted by the App.

According to another embodiment, multiple types of power outage alarm notifications may be generated. For example, a first power outage alarm notification may indicate a short interruption indicating that power was lost in the residence but that a back up system restored power to the residence. A second power outage alarm notification may be generated based on the back up time configured.

A user screen provided by the power outage service or the App may enable the user to configure specific messages to be sent to the user or to specific third parties based on the power outage notification type or based on the residence being monitored, or a combination thereof. For example, if a residence has back-up power the user may be enabled to configure the power outage notification to be sent to a caretaker of the residence and the user may be enabled to configure the text of the message to indicate a specific request, such as a specific personalized request from the user to the caretaker requesting that the caretaker refuel or recharge backup generation equipment (e.g., gas, kerosene, or oil). Further, according to another embodiment, the party receiving the notification may respond to the notification and the response may be included in a status screen provided by the power outage service or the App. The recipient of the power outage notification may be enabled to select from a number of canned responses included in the power outage notification. Alternatively, the recipient of the power outage notification may provide a personalized detailed response that the user may view via the App or the power outage service provided website.

It should be understood that various forms of fees for use of the service may be required, such as a one-time fee, regular time interval fees, per alarm fees, or other service-fee or device based model.

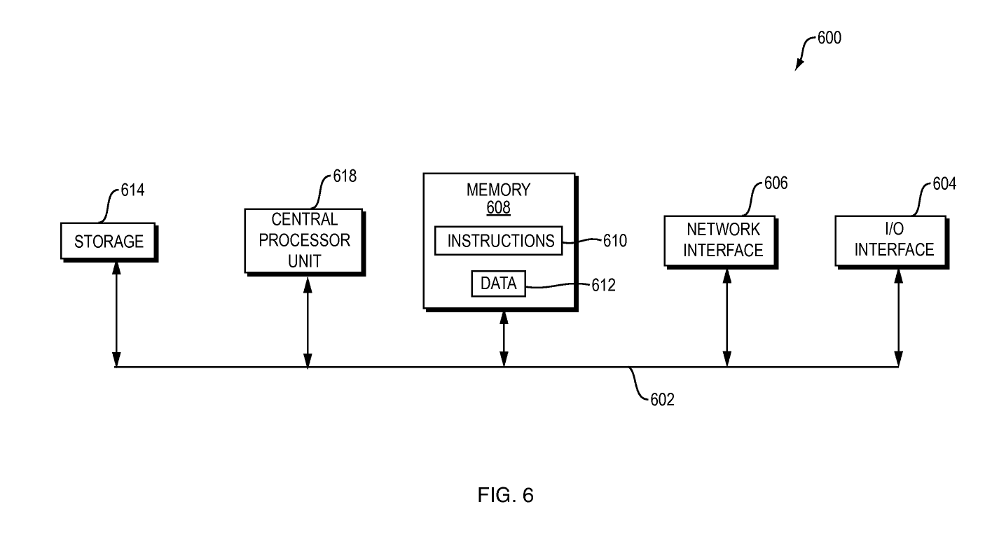

FIG. 6 is a block diagram of an example internal structure of a computer 600 in which various embodiments of the present invention may be implemented. The computer 600 contains a system bus 602, where a bus is a set of hardware lines used for data transfer among the components of a computer or processing system. The system bus 602 is essentially a shared conduit that couples different elements of a computer system (e.g., processor, disk storage, memory, input/output ports, network ports, etc.) that enables the transfer of information between the elements. Coupled to the system bus 602 is an I/O device interface 604 for coupling various input and output devices (e.g., keyboard, mouse, displays, printers, speakers, etc.) to the computer 600. A network interface 606 allows the computer 600 to couple to various other devices attached to a network. Memory 608 provides volatile storage for computer software instructions 610, and data 612 may be used to implement embodiments of the present invention. A disk storage 614 provides non-volatile storage for computer software instructions 610 and data 612 that may be used to implement embodiments of the present invention. A central processor unit 618 is also coupled to the system bus 602 and provides for the execution of computer instructions.

Example embodiments of the present invention may be configured using a computer program product; for example, controls may be programmed in software for implementing example embodiments of the present invention. Further example embodiments of the present invention may include a non-transitory computer-readable medium containing instructions that may be executed by a processor, and, when executed, cause the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

It should be understood that more manual techniques of checking the status of the remote device can be employed, such as enabling a user to make telephone calls to the device. The device may, alternatively, also send “push” notifications to a user's handheld wireless device (e.g., smart phone), which may be configured to receive a report status in an event a timeout is detected between received pushed notifications.

While this invention has been particularly shown and described with references to example embodiments thereof, it will be understood by those skilled in the art that various changes in form and details may be made therein without departing from the scope of the invention encompassed by the appended claims.

What is claimed is:

1. A method for remotely monitoring a residence, the method comprising:
monitoring an operational state of at least one network device via a network, the at least one network device operatively coupled to a power source of the residence for power;
determining a status of the power source based on the operational state of the at least one network device; and
generating a notification that provides an indication of the status of the power source of the residence.

2. The method of claim 1 wherein the notification includes a “power lost” indication or a “power restored” indication, the notification being automatically generated responsive to detection of a change of the operational state of the at least one network device.

3. The method of claim 1 wherein determining the operational state includes monitoring communications from the at least one network device.

4. The method of claim 3 wherein the communications monitored are bi-directional or uni-directional communications and further wherein:
the bi-directional communications include request messages being sent to the at least one network device and response messages being sent from the at least one network device in response to the request messages;
the unidirectional communications include status messages sent from the at least one network device; and
the notification generated is a power loss notification based on a loss of one or more response messages or one or more status messages.

5. The method of claim 1 further including suppressing the notification generated based on a fault condition of the network or determining an alternative network via which to transmit the notification based on the fault condition of the network.

6. The method of claim 1 further including enabling a user to select a presentation type for the notification generated, the presentation type including a list of at least one of: text type notification, e-mail type notification, voicemail type notification, registered service type notification, or a third-party type notification.

7. The method of claim 1 further including employing an application on a user device operatively coupled to the at least one network device via the network, the application being configured to perform the monitoring, determining, and generating.

8. The method of claim 7 wherein the application employed enables a user to select the residence among a plurality of residences available to be remotely monitored.

9. The method of claim 8 further including presenting notifications generated for multiple residences selected by the user, wherein the notifications for the multiple residences are selectively presented in a synchronous or asynchronous manner as defined by the user.

10. The method of claim 7 further including storing the application on a server operatively coupled to the network and downloading the application from the server, wherein the application is configured to provide automatic configuration for each effectuating communications with the at least one network device based on the user device being operatively coupled to the network via a connection to a Wi-Fi or local wireless network of the residence.

11. The method of claim 10 wherein the automatic configuration includes an Internet Protocol (IP) network and use of a subnet mask.

12. The method of claim 7 wherein if the user device is connected to a network connection of the residence, the application is further configured to detect a network configuration of the at least one network device and automatically configured to enable later communications between the at least one network device and the user device.

13. The method of claim 1 wherein the monitoring is performed for the at least one network device for each of multiple residences, and wherein the monitoring includes causing communications to occur with the at least one network device in every residence in a daisychained manner, and further wherein determining the operational state of the power sources of the residences is based on receipt of a communication's indicating that each at least one network device in the daisychain participated in the communications.

14. A method for remotely monitoring at least one residence, the method comprising:
enabling a user to associate contact information of a personal communications device with contact information of at least one network device of at least one residence, the at least one network device being powered by a power source of the respective residence;
observing the at least one network device via a network in determining a status of the power source based on an operational status of the at least one network device; and
notifying the user via the user device of a status of the power source based on results of the observing.

15. The method of claim 14 wherein the observing includes one or more ping requests and the state of power is determined to be a power loss based on a timeout of one or more responses to the at least one ping request.

16. The method of claim 14 wherein the personal communications device is a smart phone and further comprising transmitting an application to the smart phone via the network or providing information to the smart phone to enable a user to initiate downloading of the application.

17. The method of claim 14 further including enabling the user to associate a third party responsible for providing power to at least one residence and further including notifying the third-party based on a change in the status of the power loss determined.

18. The method of claim 14 wherein the at least one network device is located at a location external from at least one of the plurality of residences.

19. The method of claim 14 wherein the observing and notifying are done on a subscription service basis, one-time basis, on-demand basis, or no fee on-going basis.

20. An apparatus for remotely monitoring a residence, the apparatus comprising:
a processor operatively coupled to a network interface and a power source of a residence; and
a non-transitory computer-readable medium coupled to the processor, the non-transitory computer-readable medium having encoded thereon a sequence of instructions which, when loaded and executed by a processor, causes the processor to send messages or responses to messages to a power loss monitoring device via a network operatively coupled to the processor via the network interface.

21. The apparatus of claim 20 wherein the sequence of instructions further causes the processor to send the messages or responses to messages at a rate based on a messaging rate configuration setting received via the network interface from the power loss monitoring device over the network.

22. The apparatus of claim 20 wherein the sequence of instructions further causes the processor to send the messages or responses to messages in response to a request message received via the network interface from the power loss monitoring device over the network.

23. The apparatus of claim 22 wherein the request message is a ping and the message sent in response to the ping is a ping response.

24. The apparatus of claim 20 wherein the processor is operatively coupled to the power source of the residence by electrically coupling the processor to the power source via a power outlet of the residence.

25. The apparatus of claim 20 wherein the processor is operatively coupled to the power source of the residence by electrically coupling the processor to a connector of the at least one network device in the residence.

26. The apparatus of claim 20 wherein the network interface is a wired or wireless connection.
